(19) United States
(12) Patent Application Publication
(10) Pub. No.: US 2015/0158183 A1
(43) Pub. Date: Jun. 11, 2015

(54) Powered Drive and Control Mechanism for hand held gripping devices

(71) Applicant: THOMAS OTTO MCNAY, LOVELAND, OH (US)

(72) Inventor: THOMAS OTTO MCNAY, LOVELAND, OH (US)

(73) Assignee: THOMAS OTTO MCNAY, LOVELAND, OH (US)

(21) Appl. No.: 14/557,134

(22) Filed: Dec. 1, 2014

Related U.S. Application Data
(60) Provisional application No. 61/963,461, filed on Dec. 5, 2013.

(51) Int. Cl. B25J 13/02; B25J 19/00; B25J 1/04

(52) U.S. Cl. CPC B25J 13/02; B25J 1/04; B25J 19/005

(57) ABSTRACT

This is a Powered Drive and Control Mechanism for improving the operation of hand held manually operated gripping/reaching devices. Manually operated Reaching/grabber devices are spring loaded to open so they require the user to have good strength and dexterity to close them and keep them closed around an object being reached. Many users have physical limitations making these tools difficult or impossible for then to operate. With this lightweight battery powered Drive and Control Mechanism incorporated into a gripping/reaching tool an operator only needs to touch a button for opening or closing the tool and it has an inherent ability to hold items in its grip without the operator having to hold it closed. This design allows it to be used by persons that would not have the ability to operate a gripper/reaching tool otherwise.

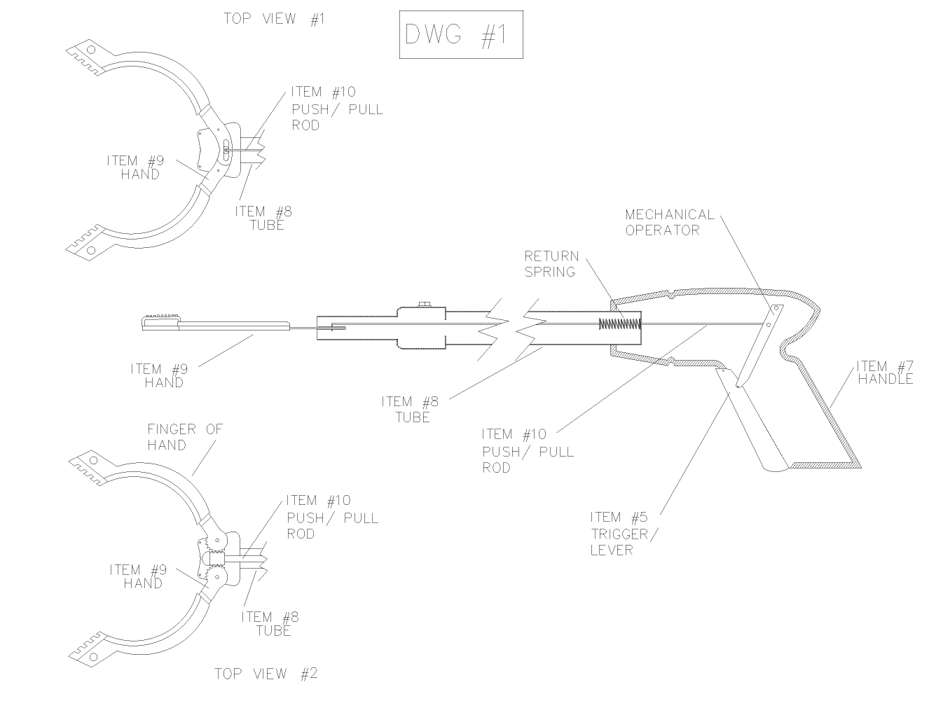

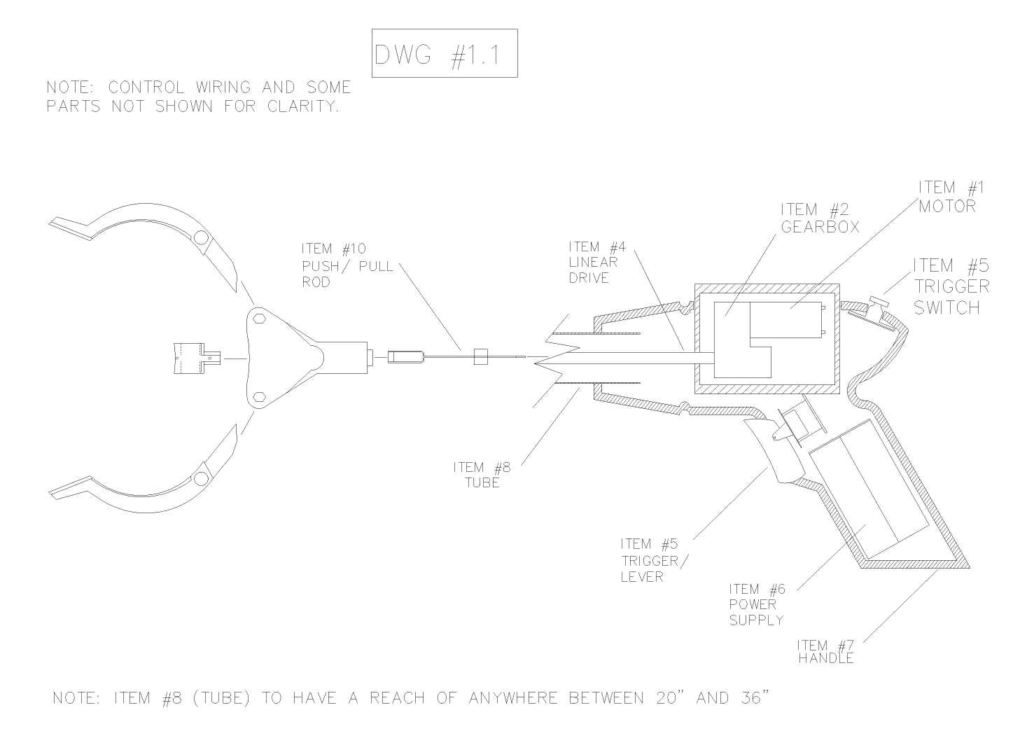

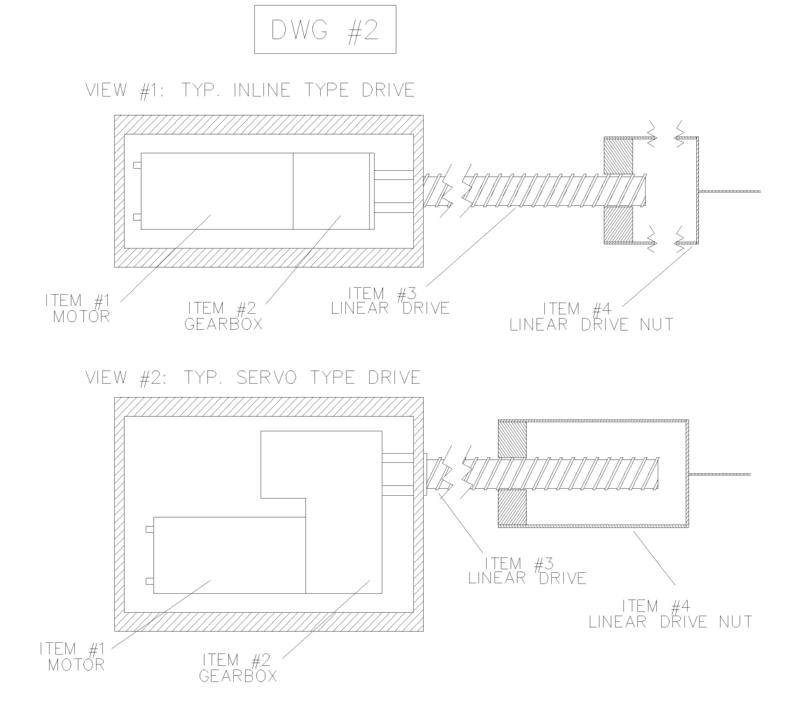

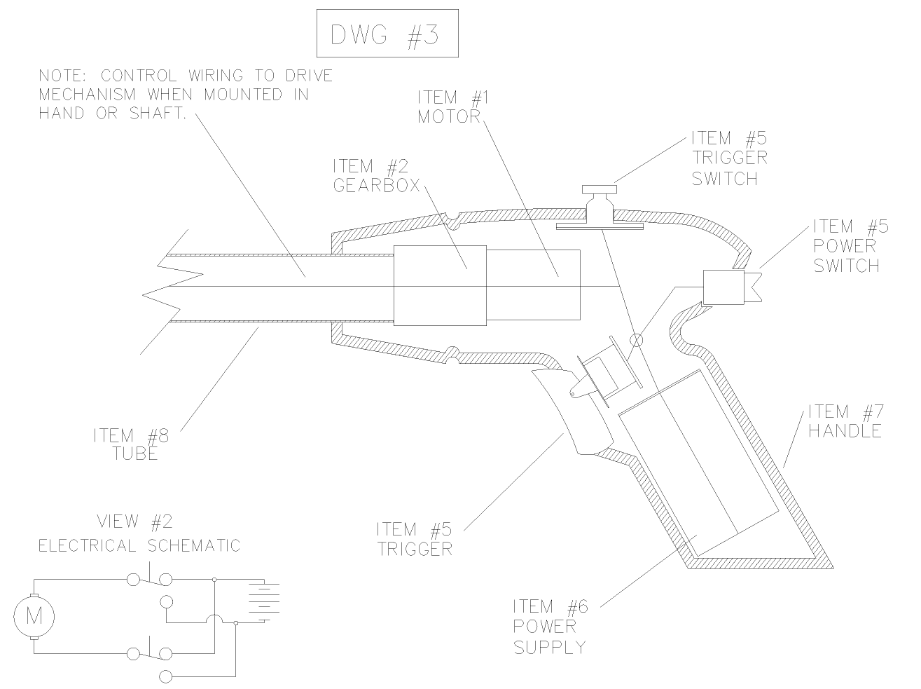

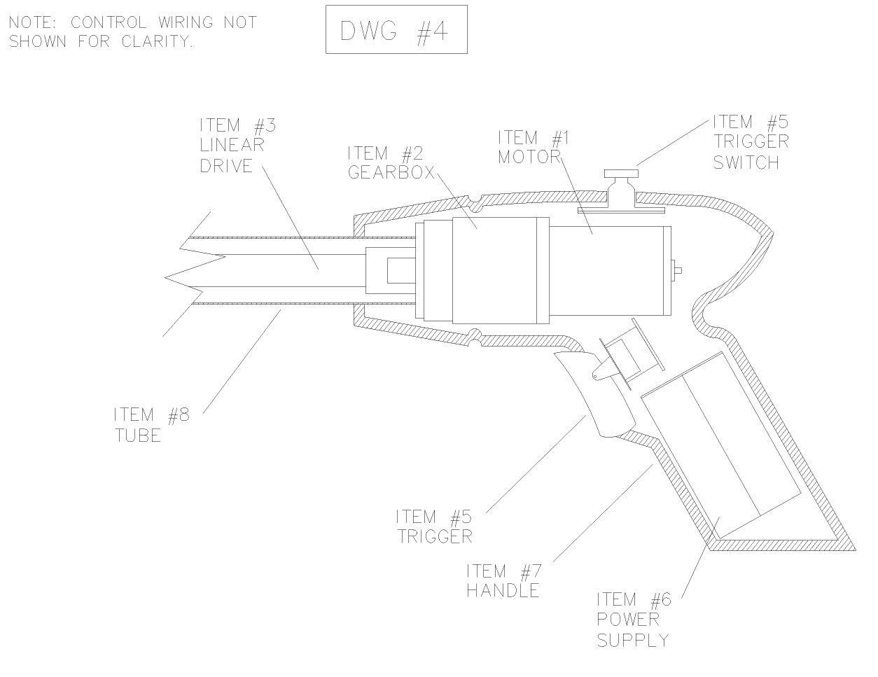

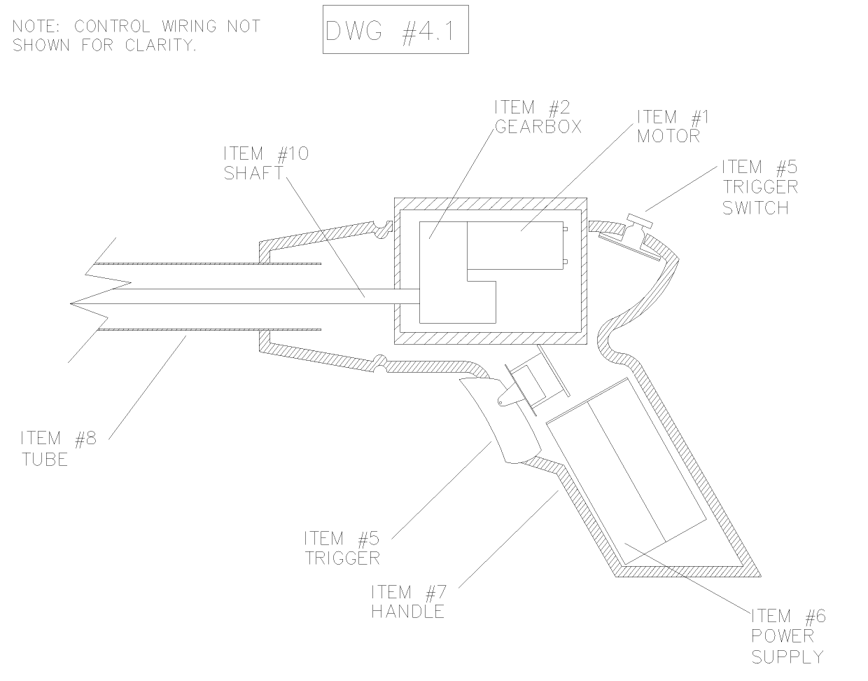

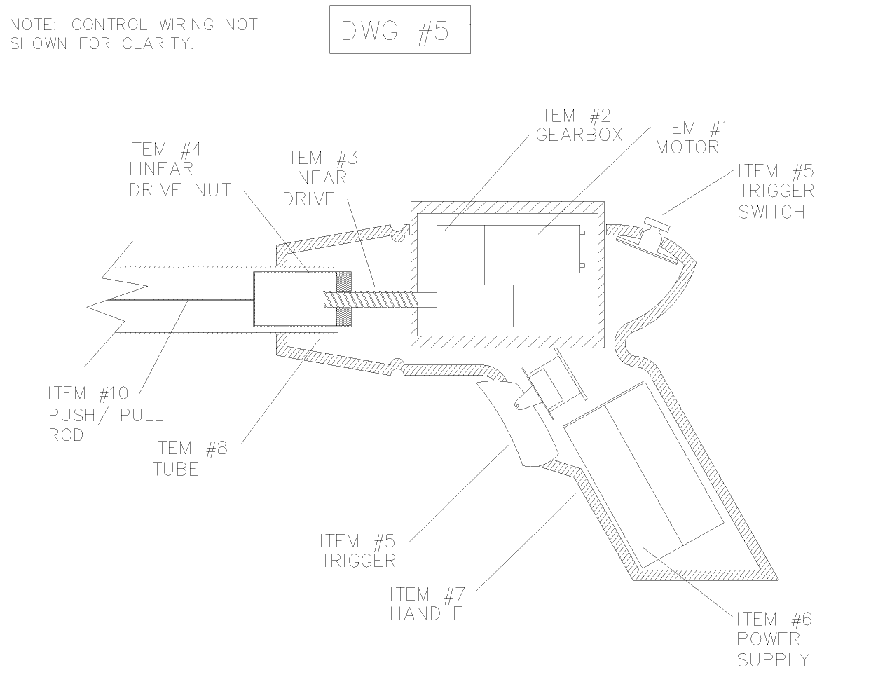

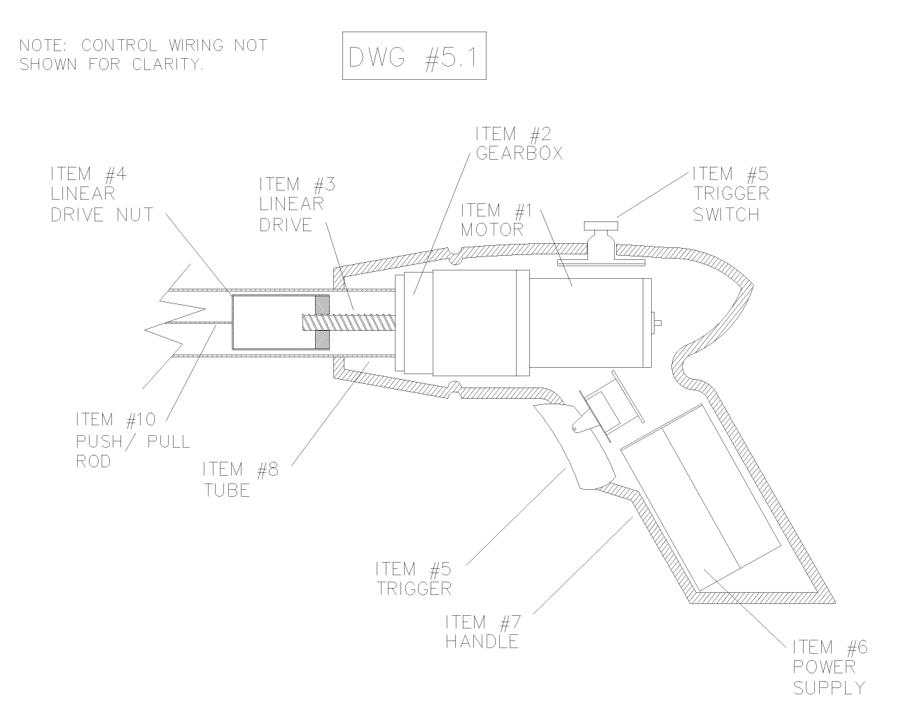

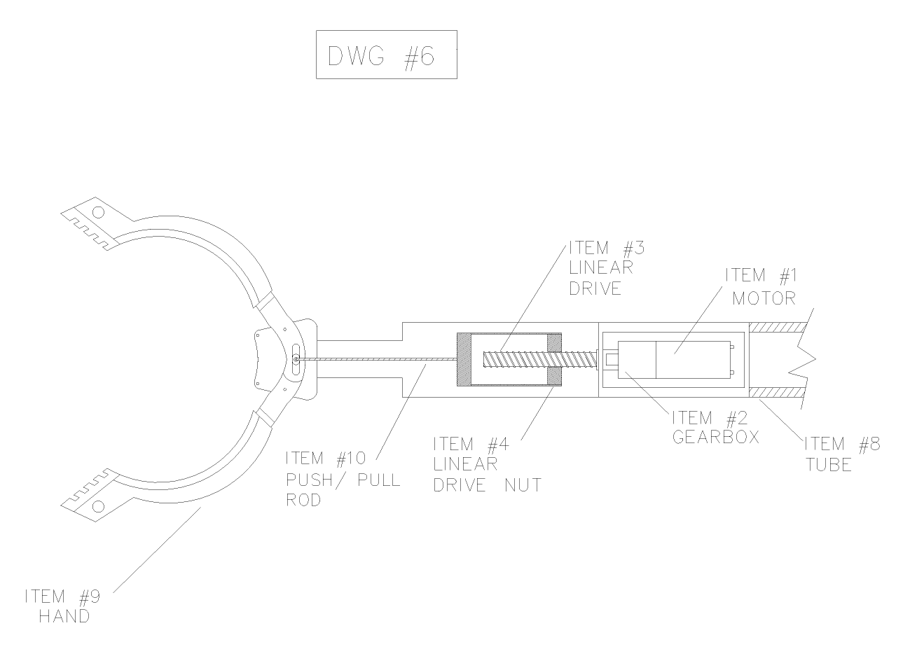

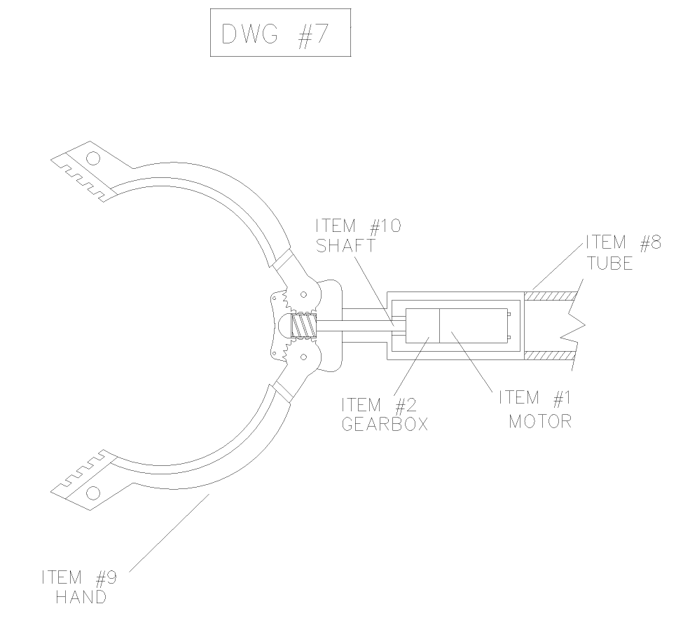

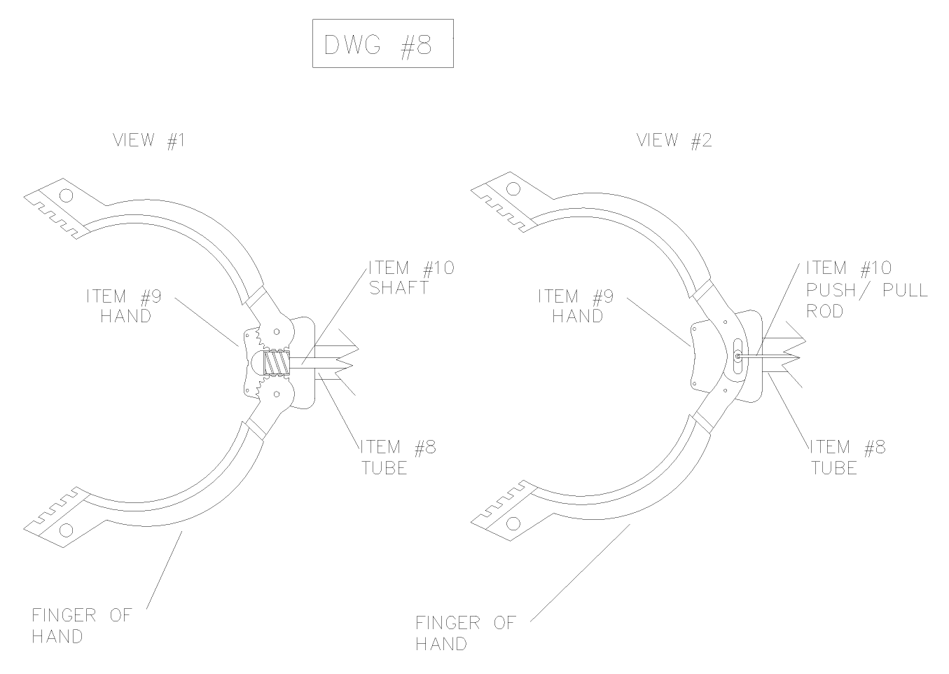

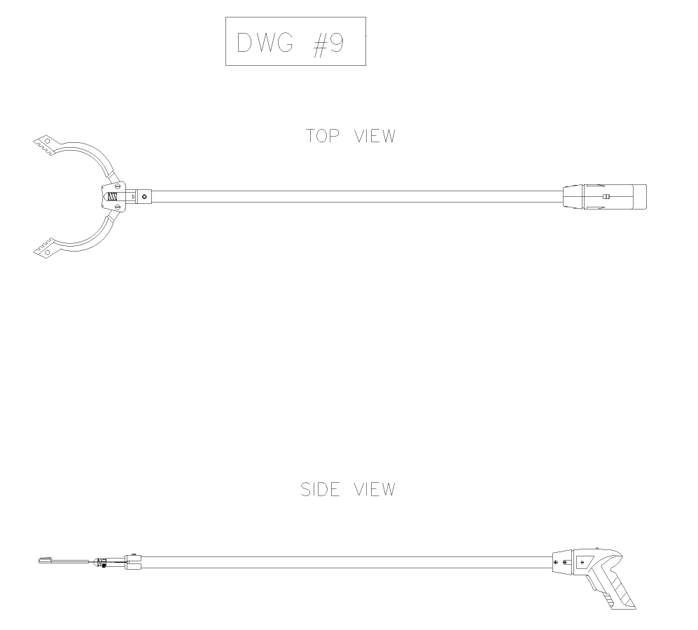

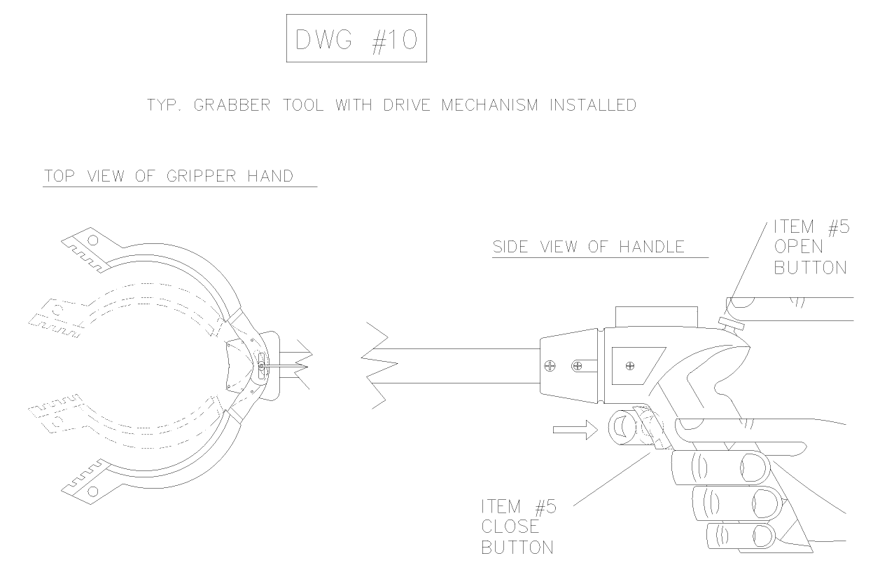

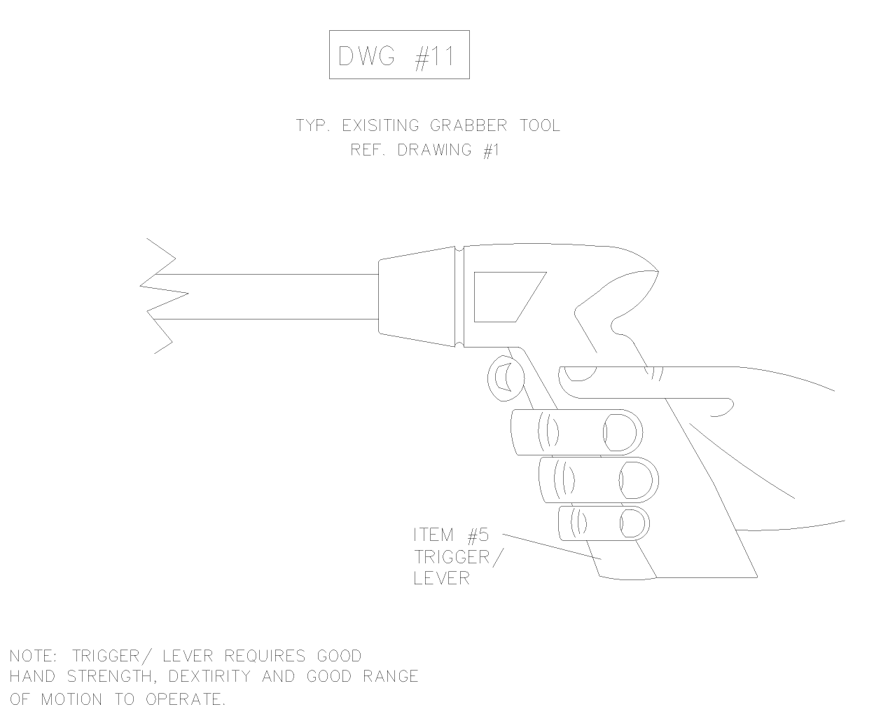

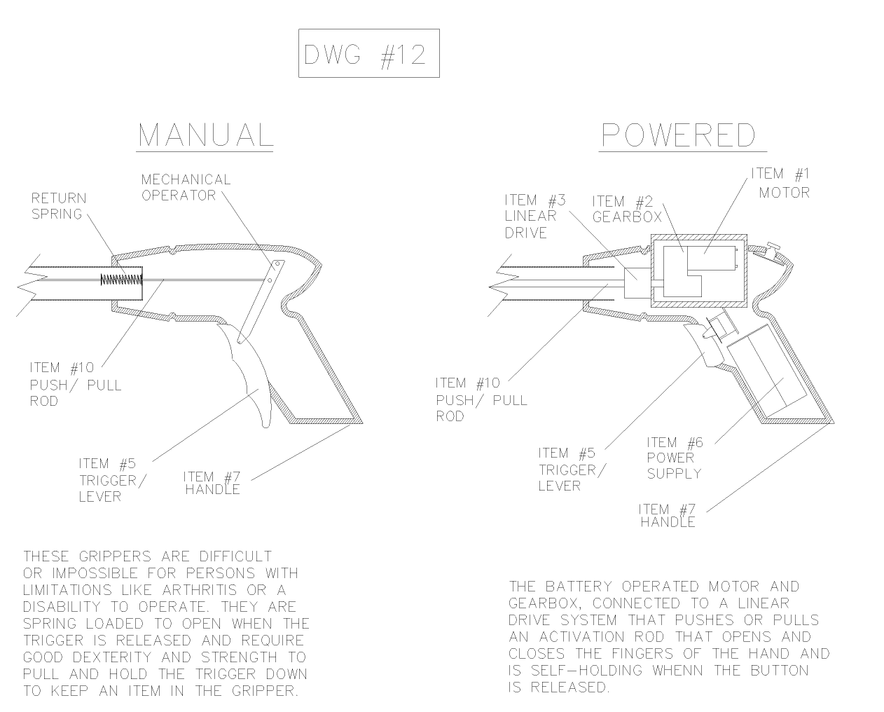

### CROSS-REFERENCE

Provisional patent application No. 61/963,461: Confirmation # 4979 Dec. 20, 2013

### BACKGROUND OF THE INVENTION

Manual Reaching/grabber tools are used by people that need help reaching items in their daily activities. But these tools are manually operated, requiring the user to have good strength to use. The users that need them the most have physical limitations, like arthritis, a disability, poor hand strength or dexterity. These tools are difficult and sometimes impossible for persons with limitations to operate. (DWG. #1 (1.pdf) and (DWG. #11 (14.pdf) Many users can't hold the lever pulled down while moving what they are holding in the grabber. There are millions of people in the U.S. with a disability and millions more that just don't have the strength that is needed to operate a manual grabber.

### SUMMARY OF THE INVENTION

This invention is directed to the improvement of manually operated, gripping, grabber or reaching type tools, as illustrated In (DWG. #1 (1.pdf) so that users with disabilities, limited dexterity, mobility and/or strength limitations would be able to operate them with much less effort.

When this “Drive Mechanism” is incorporated into a gripping/reaching tool it allows users to operate it with just a touch of a button. Its battery operated miniature motor and drive system, pushes and/or pulls the gripper activation rod. This opens and closes the grabber with just a touch of a button. Once closed this design automatically holds the gripper in the closed position until the operator releases it. It has the ability to be used to retrieve items dropped in water, snow or in the washing machine. This “Drive Mechanism” removes the limitations of operating a manual gripper. Drawings (DWG. #1 (1.pdf) & (DWG. #11 (14.pdf) show a manual gripper operation. Drawings (DWG. #1.1 (2.pdf) & (DWG. #10 (13.pdf) show the gripper with the “Drive Mechanism” installed.

### DESCRIPTION OF THE DRAWING VIEWS

All components within the drawings are typical. Their locations of components may change, dependent on gripper/reaching tool design and or construction.

WITHIN all DRAWINGS, item numbers are as follows:

ITEM #1—DC motor (supplies rotational power to the gearbox (item #2)

ITEM #2—Gearbox (receives rotational power from the motor and reduces the RPM).

ITEM #3—Linear drive (receives rotational power from the gearbox, converts it to linear motion using the linear drive nut (item #4)

ITEM #4—Linear drive nut (travels along the linear drive and transfers this motion to the (push/pull rod or cable) (item #10)

ITEM #5—Trigger/switch (conducts power from the power supply (item #6) to the DC drive motor (item #1)

ITEM #6—Power supply/battery pack (supplies DC power for operation of the motor (item#1)

ITEM #7—Handle of the reacher/grabber, original or redesigned handle for holding and operating the gripper/reacher. Rigid tube is connected to handle (item #8)

ITEM #8—Rigid tube, connects the handle (item# 7) to the hand (item # 9) and houses the push/pull rod, shaft or cable (item #10)

ITEM #9—Hand with its fingers and actuating mechanism (original or a redesigned hand with its fingers used to grip and hold items) operated by the shaft, push pull rod or cable (item #10) and connected to the rigid tube (item #8)

ITEM #10—Shaft, push/pull rod or cable (original or a redesign, attached to the hand actuating mechanism (item #9) and the linear drive (items #3 and #4) used to operate the fingers of the hand.

### DRAWING DESCRIPTIONS

### With View Descriptions

DRAWING #1—(1.pdf) Two types of mechanical gripping tools, (Drawing #1, View #1) typical mechanical handle and operating mechanism. (Drawing #1, View #2) Typical push/pull hand-operating mechanism. (Drawing #1, View #3) Shows a typical gear type hand operating mechanism. This drawing is used for reference of a manually operated gripping/reaching tool before the “Drive Mechanism” would be incorporated.

DRAWING # 1.1—(2.pdf) View of typical gripper/reacher with the “Power Drive and Control Mechanism” installed. Placement of components can vary dependent of design of gripper/reacher.

DRAWING #2—(3.pdf) Two variants of the “Dive Mechanisms” (Drawing #2, View 1) is an inline drive system with motor and gearbox located inline with each other. (Drawing #2, View 2) is a servo type drive mechanism. Motor and gearbox are located side by side, offsetting the drive output.

DRAWING #3—(4.pdf) (Drawing #3, view #1) typical switch and battery location within the handle of gripping/reaching tool. These components can be located in various locations depending on design of handle and location of “Dive Mechanism”. (Drawing #3, view #2) Shows a typical control wiring electrical schematic used for control of the “Dive Mechanism”.

DRAWING #4—(5.pdf) Typical Inline type drive mechanism with rotatory shaft output (no linear drive) incorporated into handle with typical switch and battery locations. Linear drive may be located elsewhere in gripper/reacher

DRAWING #4.1—(6.pdf) Typical servo type drive mechanism with rotatory shaft output (no linear drive incorporated) incorporated into handle with typical switch and battery locations. Linear drive may be located elsewhere in gripper/reacher.

DRAWING #5—(7.pdf) Typical servo drive mechanism and linear drive, incorporated into handle with typical switch and battery locations.

DRAWING #5.1—(8.pdf) Typical Inline drive mechanism and linear drive, incorporated into handle with typical switch and battery locations.

DRAWING #6—(9.pdf) Typical Inline drive mechanism and linear drive incorporated into the shaft of a gripping/reaching tool, operating push/pull hand mechanism.

DRAWING #7—(10.pdf) Typical Inline drive mechanism incorporated into the shaft of a gripping/reaching tool, operating a “rotating gear” hand operation mechanism.

DRAWING #8—(11.pdf) Two typical hand operating systems. (Drawing #8, View #1) A rotating gear driving two semi circular gears, thus driving the fingers to open or closed. (Drawing #8, View #2) a push/ pull rod or cable operating the fingers through a sliding cam or wedge thus opening and closing the fingers.

DRAWING #9—(12.pdf) Two typical external views (top and side) of a gripper/reaching tool with the “Drive Mechanism” installed within the handle.

DRAWING #10—(13.pdf) View of a typical gripper/reaching tool handle having the “Drive Mechanism” installed within the handle. Showing the method of operation, using the touch of a finger on a button to open or close the hand.

DRAWING #11—(14.pdf) View of a typical mechanical gripper/reaching tool. Showing the method of operation, by having to squeeze the closing trigger with the complete hand to overcome the return spring tension.

DRAWING #12 (15.pdf)—Comparison cutaway drawings of a typical manual gripper/reaching tool and a gripper/reaching tool with the “Powered Drive and Control Mechanism” incorporated.

### DESCRIPTION OF INVENTION

### Powered Drive and Control Mechanism for Hand Held Gripping Devices

The “Drive Mechanism” (see DWG. #1.1 item #1 (1.pdf)) is electrically operated by DC current from a battery, that powers a DC motor connected to a speed reduction gearing system, coupled to a drive shaft and/or a linear drive mechanism that rotates, pushes or pulls an activation rod, shaft or cable, which in turn closes and opens the fingers of the hand, thru the hands and finger activating mechanism. This gear reduction and linear drive system (see DWG. #2, view #1 or #2 (3.pdf)) provides self-holding of the fingers when power is removed from the drive mechanism. The below description explains the Powered Drive and Control Mechanism along with its relation to the gripping/reaching tool that it would be incorporated into, including but not limited to the components and their operation in relation to the Powered Drive and Control Mechanism and their relationship to a gripper/reaching tool.
A) A small DC electric motor, (DWG. #2, views #1 and/or #2, (3.pdf)) driven by DC current from a power supply (DWG. 3, item #6 (4.pdf)), thru the control system (DWG. 3 items #5 (4.pdf)), supplies the rotational power to the gear box (DWG. #2, views #1 and/or #2 (3.pdf)) This motor would operate clockwise (CW) or counter clockwise (CCW) to allow the opening or closing of the hand through the CW or CCW rotation of the gearbox, thus changing the directional movement of the linear drive that's attached to a rod, shaft or cable thus activating the hand closing and opening. The size and power output of this motor would match the power needs for proper operation of the hand. The motor/gearbox could be housed in (DWG. #4 (5.pdf)) and #4.1 item #7 (6.pdf)), (DWG. #5 (7.pdf) and #5.1 item #7 (8.pdf)), (DWG. #6. Item#8 (9.pdf)) or (DWG. #7 item #8 (10.pdf)).
B) Gearbox: (DWG. #2, views #1 or #2 (3.pdf)) This takes the rotational output from the DC drive motor (DWG. #2 views #1 or #2, items #2 (3.pdf)) and reduces the RPM, thus increasing the torque output by a system of gears, be it worm type, planetary or multi gear reduction, or a combination of these. This gearbox can be a separate device or incorporated into a motor making a motor/gearbox combination. The speed of the gearbox output shaft is matched for the ratio of the linear drive (DWG. #2 views #1 or #2, items #3 and #4 (3.pdf)) for the operational needs of the gripper, as in the speed of opening/closing and the closing force for the hand/fingers. The gearbox or the motor/gearbox combination could be housed in the handle, rigid tube or a separate enclosure. (DWG. #4 (5.pdf)) and #4.1 item #7 (6.pdf)), (DWG. #5 (7.pdf) and #5.1 item #7 (8.pdf)), (DWG. #6, Item #8 (9.pdf)) or (DWG. #7 item #8 (10.pdf)).
C) Linear drive: (DWG. #2 views #1 or #2, items #3 and #4 (3.pdf)) This uses the output from the gearbox (DWG. #2 views #1 or #2, item #2 (3.pdf)) and converts it to linear motion thus increasing the output force to the push/pull rod or shaft. The linear drive is composed of a spiral drive gear/shaft of SAE, metric or acme type threads, connected to the output of the gearbox (DWG. #2 views #1 or #2, item #2 (3.pdf)) thus rotating and driving a matching drive nut, that is on the spiral drive gear, running linear and parallel to the spiral drive gear/shaft. The drive nut then pushes or pulls a drive shaft or rod, shaft or cable (DWG. #2 views #1 or #2, item #4 (3.pdf)) connecting to the finger actuating system within the hand (DWG. #8, view #2, item #10 (11.pdf)). Thru these design elements it integrates an inherent position/self-holding ability. The leverage ratio between the fingers of the hand and the linear drive (DWG. #2 views #1 or #2, item #4 (3.pdf)) will hold the fingers in place without the need for continuous force being applied by the “Drive Mechanism” (DWG. #2 views #1 or #2 (3.pdf)). This linear drive could be housed in the handle, rigid tube, hand or alternant mounting locations. Examples of locations are (DWG. #5 (7.pdf)), (DWG#5.1 (8.pdf)), (DWG. #6 (9.pdf)).
D) Drive shaft or rod: (DWG. #2, view #1 or #2 item #4 (3.pdf)). This connects the linear motion output of the linear drive (DWG. #2, view #1 or #2 item #3 (3.pdf)) and transfers this motion to the hand (DWG. #8 view #2 (8.pdf)) to operate the opening/closing mechanism of the fingers. This can be the original “tools” push/pull rod or drive shaft (DWG. #1, view #1 item #10)) connected thru the original hand (DWG. #1, view #2 item #9 (1.pdf)), to the finger movement mechanism of the original mechanical gripping tool.
E) Control system: (DWG. #3 view #1 and #2 (4.pdf)) This is the control for the DC current from the power supply (DWG. #3 view #1 item #6 (4.pdf)) to the drive motor (DWG. #3, view #1 item #1 (4.pdf)) thru an electric circuit (DWG. #3, view #2 (4.pdf)) that allows the operator to run the motor CW or CCW or to stop the motor using switches thus controlling the opening, closing, and stopping/holding of the fingers in the hand. A power on/off switch can also be incorporated to turn off all power to the motor and controls when not needed. The circuit is constructed in such a way as to not permit the opening and closing control switches to conduct current to the motor simultaneously. This can be 2 switches or one with multi contacts (DWG. #3, view #1 items # 5 (4.pdf)). This would be housed in the handle (DWG. #3, view #1 item (4.pdf)). Location of control switches would vary dependent of design of the handle.
F) Power supply system (batteries): (DWG. #3, view #1 item #6 (4.pdf)) this consists of replaceable or rechargeable batteries or a battery pack to supply the DC current to the control system (DWG. #3, view #2 (4.pdf)) and drive motor (DWG. #3, view #1 item #1 (4.pdf)). This battery pack would be of the correct voltage and power rating to match with the requirements of the drive motor (DWG. #3, view #1 item# 1 (4.pdf)). This could be housed in the handle (DWG. #3, view #1 item#7 (4.pdf)) or another location within, or mounted on the gripping/reaching device, being dependent on the design of the tool.
G) Alternate mounting locations for the motor and/or gearbox, the linear drive, the battery or the controls could be in or on the rigid shaft, the handle, the hand or an additional mounting system. (DWG. #1, items # 5, 7, 8, or 9 (1.pdf)) or a redesigned mounting system to coincide with the gripper/reacher design.

A) Persons with physical disabilities can't effectively use a manually operated gripping/reaching “tool”, because of their limited dexterity, mobility, strength and or range of movement (DWG. #11 (14.pdf)). This “Drive Mechanism” removes or minimizes these limitations (DWG. #10 (13.pdf)). (DWG. #11 (14.pdf)) is a manually operated gripper. With a manual gripper the operator must manually close the fingers of the hand by pulling a trigger or squeezing a handle that is mechanically connected to the fingers of the hand after overcoming the spring tension that keeps the fingers in the open position. (DWG. #1 view #1 (1.pdf)). This requires good strength and dexterity. This “Drive Mechanism” (DWG. #2, views #1 or #2 (3.pdf)) when incorporated into a “tool” removes the manual operation of these “tools” and replaces it with an electric powered system that only takes a light touch of a button or trigger to operate (DWG. #10 item #5 (13.pdf)).

B) Existing devices, helping hands, grippers, reaching “tools” (DWG. #1 (1.pdf)) etc. are held open by a spring. This requires the operator to manually hold the handle/trigger pulled to keep the device closed, requiring good hand strength and dexterity to operate. Then while still holding the handle/trigger pulled, the operator would move the “tool” to the location where they would like to release the item all the time holding the trigger/handle pulled, thus making a manual operated “tool” impossible for a person with dexterity or strength limitations to operate effectively. For a person that must operate a mobility device (wheel chair, scooter, power chair, etc.) they would not be able to hold a manual grapping device closed (claim C) and also operate the mobility device at the same time. With the addition of the drive mechanism, and its self-holding feature, it leaves the operators hands free to operate his or hers mobility device.

C) This “drive mechanism” is designed in such a way that when incorporated into a manually operated gripping “tool”, it improves its design into a mobile, portable, electrically operated, reaching, gripping “tool” that is ideal for persons with disabilities or limited mobility to operate. It enables persons with disabilities to use it effectively, because of its self-powered design. It can be closed or opened with one hand or both and the design of the controls make it possible for the operator to release the controls completely and the tool will remain in whatever position it was in. This keeps the item they are picking up held in the gripper while moving to another location. Some examples of operation when the controls must be released to achieve these tasks include; Retrieving items too far back in a refrigerator, removing items from a washing machine or drier, picking up dropped items, operating a mobility device with an item in the reacher, reaching something that is too high on a shelf, picking an item out of a low cabinet.

D) This “drive mechanism” when incorporated into a gripping device, (tool); because of its relative ease of operation would help relieve the repetitive motion of closing and opening the hand, that is a major cause of issues such as carpel tunnel syndrome. These gripping tools are often used to pick up trash in parks, playgrounds etc. by service personnel. The repeated pulling of the trigger and holding it closed can put undo stress on the hand that can develop into carpel tunnel syndrome.
